(19) United States
(12) Patent Application Publication
(10) Pub. No.: US 2014/0302451 A1
(43) Pub. Date: Oct. 9, 2014

(54) REMOVABLE ORTHODONTIC RETAINER

(71) Applicant: TP Orthodontics, Inc., (US)

(72) Inventor: Randall Berry, LaPorte, IN (US)

(73) Assignee: TP Orthodontics, Inc., LaPorte, IN (US)

(21) Appl. No.: 13/761,907

(22) Filed: Feb. 7, 2013

(51) Int. Cl. A61C 7/00

(52) U.S. Cl. CPC A61C 7/00
USPC 433/18

(57) ABSTRACT

A removable orthodontic retainer for correction of minor irregularities and to retain the corrected positions of the teeth which includes a labial bow having biasing means that causes the labial bow to be continually active on the anterior teeth.

### TECHNICAL FIELD

The invention relates in general to an orthodontic appliance and, more particularly, to a removable orthodontic retainer or aligner that is employed by a patient after the patient has had orthodontic treatment with fixed appliances. The retainer serves to correct minor incisor irregularities and/or retain the position of orthodontically corrected teeth. More particularly, the invention relates to a preformed appliance that is custom made over a model of the patient's teeth or a setup. When placed with a patient, it is used to maintain the incisors in an ideal location, so that they can thereafter be permanently set in the jaw of a patient. The appliance will contact some or all of the incisors in order to obtain the position of the incisors that have been obtained through the use of fixed appliances.

### BACKGROUND OF THE INVENTION

It has been known to provide various types of appliances for correcting minor incisor irregularities and for retaining teeth in corrected position for either the upper or lower anterior teeth subsequent to the treatment of a patient with fixed appliances. Some of those appliances are shown in U.S. Pat. Nos. 3,994,068, 4,224,021 and 6,135,767. However, the appliances disclosed in these patents have required considerable repair after use and sometimes readjustment, which reduces the usefulness of the appliances during those times needed to make changes. Moreover, they have not all been esthetically pleasing and, accordingly, there is a need to provide a removable orthodontic retainer or liner that will not be subject to the need for repairs or readjustment and which will be esthetically pleasing to the patient.

### SUMMARY OF THE INVENTION

The invention is a new and improved removable orthodontic retainer or aligner that is structurally made to not need adjustments or repairs on the basis that it is continually active on the anterior teeth of a patient to maintain them in proper positions, according to a patient's mouth, teeth or a setup. The appliance includes a labial bow, which is positioned over the labial surfaces of the anterior teeth and particularly the incisors and anchored at its distal ends to a biasing means which coacts with a guide means and spring to continually apply spring pressure to the labial bow for contacting the labial surfaces of the anterior teeth.

The biasing means includes a tubular guide means through which the distal ends of the labial bow are received and which guide means are interconnected to a rigid base at the lingual sides of the teeth. The rigid base may be in the form of a palatable plate, or otherwise have suitable sockets engaging the lingual sides of the anterior teeth and at least some of the posterior teeth. The structure for biasing the labial bow includes a spring associated with tubular guides and bottomed at one end against the tubular guides and at the other end against a crimpable stop at the very distal ends of the bow. This structure overcomes the need to provide retightening adjustments of the appliance or other types of adjustments and also inhibits the fracturing of any components. The labial bow is in the form of a multi-stranded wire encased in a suitable plastic material, which may be colored to the color of the teeth and, therefore, be substantially invisible to a person looking at the patient wearing the appliance. Moreover, the crimpable stops at the very distal ends of the labial bow are also colored to blend with the color of the teeth, in order to reduce any noticeable differences in color and, therefore, be esthetically pleasing. The multi-stranded wire in the labial bow may preferably be a braided wire and of a nickel-titanium material. Similarly, the springs at the distal ends of the bow are of a nickel-titanium material, which enhances their life and produces continuous pressure against the labial bow to engage the labial surfaces of the anterior teeth. Cross-sectionally, the bow is substantially square to define a flat surface for employment against the anterior teeth.

It is, therefore, an object of the invention to provide a new and improved orthodontic retainer for not only correcting minor incisor irregularities, but also to maintain the anterior teeth in ideal positions during the use of the appliance.

A further object of the invention is to provide a removable orthodontic retainer including a labial bow that acts on the labial surfaces of the anterior teeth, and particularly the incisors, and which is anchored at its distal ends and where a spring means is provided to apply tension to the bow so that it is always in engagement with the anterior teeth.

Another object of the invention is to provide a labial bow that could be used on any other appliance and that would be esthetically pleasing and which does not require reactivation or adjustment during the use of the appliance.

Other objects, features, and advantages of the invention will be apparent from the following detailed disclosure taken in conjunction with the accompanying sheets of drawings, wherein like reference numerals refer to like parts.

### BRIEF DESCRIPTION OF THE DRAWINGS

FIG. 1 is a front elevational view of the appliance mounted on a partially broken away model or setup of a patient's teeth;

FIG. 2 is a side elevational view of the appliance shown in FIG. 1 and illustrating how the appliance is attached to a lingual rigid base;

FIG. 3 is a bottom plan view of the appliance mounted on a model of the patient's teeth or a setup to illustrate the parts and their interaction with the teeth;

FIG. 4 is a perspective view of the appliance of the invention removed from the model of the patient's teeth;

FIG. 5 is a bottom plan view of the appliance shown in FIGS. 1-4;

FIG. 6 is a side elevational view of the appliance;

FIG. 7 is a greatly enlarged side elevational view of the distal end of the labial bow and the structure which mounts the distal ends in a guide structure, and showing a double open-ended spring and crimpable stop to apply continuous tension to the labial bow when engaging the anterior teeth;

FIG. 8 is a greatly enlarged cross-sectional view taken substantially along line 8-8 of FIG. 7;

FIG. 9 is a greatly enlarged cross-sectional view of the crimpable stop and taken substantially along line 9-9 of FIG. 7; and

FIG. 10 is a cross-sectional view of the labial bow and taken substantially along line 10-10 of FIG. 7.

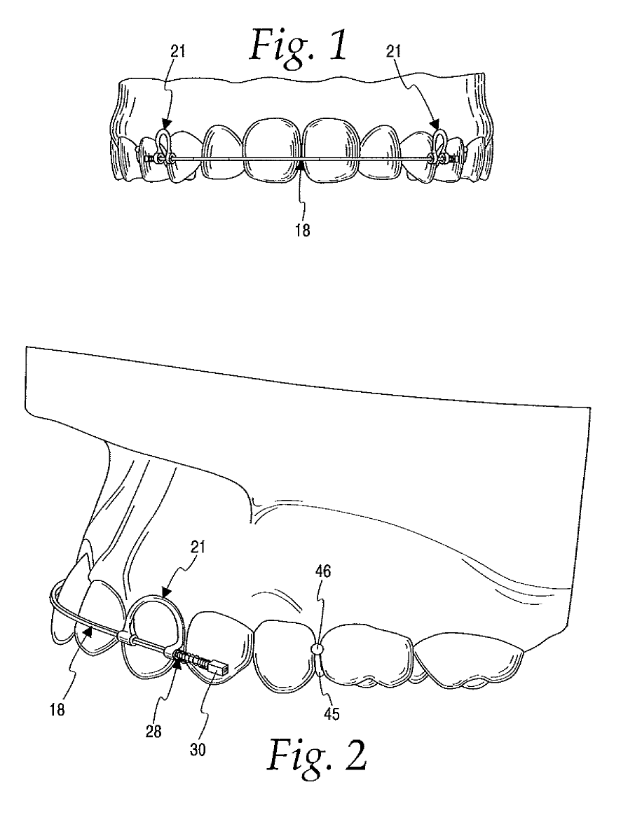

### DETAILED DESCRIPTION

The removable retainer of the invention is custom formed to fit a particular patient. It is formed over a plastic model of the teeth of a patient or a setup of the teeth, where they are in ideal positions. It is then administered to the patient with instructions as to how it is to be mounted on the teeth and used. While the appliance illustrated in the drawings is for the upper teeth, it can be appreciated that the appliance could be used to work on the lower teeth and have a rigid base at the lingual sides of the teeth to which the labial bow would be mounted. It should also be appreciated that the labial bow of the appliance can be used with other types of appliances and be an effective appliance to be used for orthodontic treatment of a patient.

The appliance of the invention is generally designated by the numeral 15, as particularly seen in the drawings and in connection with FIGS. 4, 5 and 6, where the appliance is removed from the teeth of the model.

The appliance includes a labial bow 18 received at its distal ends by a guide and spring structure 21 that is in turn connected to a lingual rigid base 25.

The labial bow 18 is comprised of a multi-stranded wire 19 encased in a plastic 20. While the multi-stranded wire 19 may be of any suitable type, it is preferably a braided arch wire that has been previously used as an orthodontic arch wire engaging arch wire slots in brackets mounted on teeth. It will be appreciated that the multi-stranded wire 19, as illustrated, is not the exact form, but it illustrates multi-stranded wire that is used in connection with the labial bow. The multi-stranded wire 19 is encased in plastic and the cross-sectional shape of the labial bow is essentially square in shape, although it could be appreciated that it could be of other shapes. Preferably, it will have at least one surface that is flat which can bear against the labial surfaces of the incisors. The plastic used to encase the multi-stranded wire will be of a suitable flexible type usable in the mouth of patients. Moreover, the plastic may be suitably colored to match the general color of a patient's teeth, so that is esthetically pleasing and substantially invisible to someone looking at it.

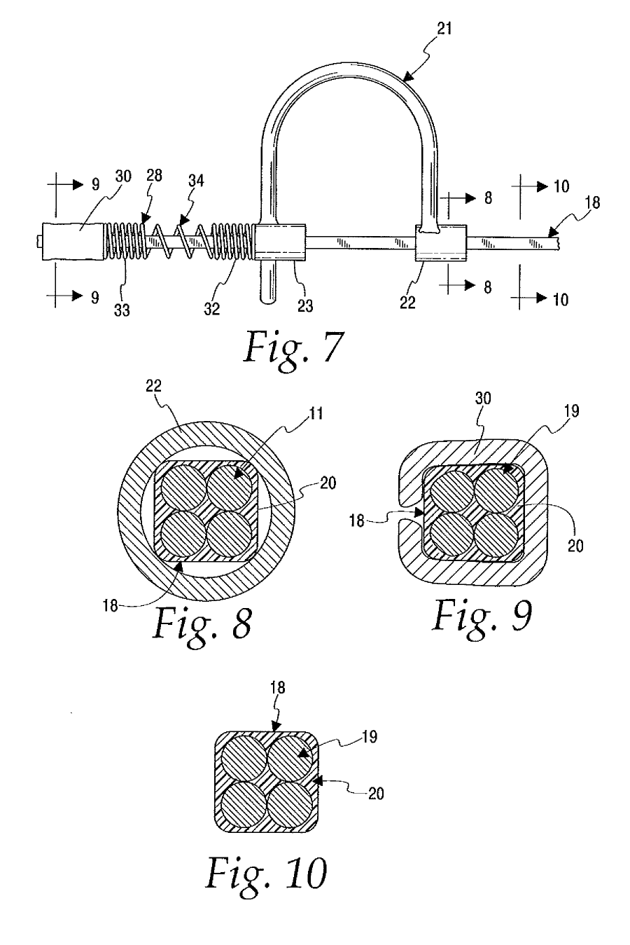

The distal ends of the labial bow 18 are slidably received in the tubular guides 22 and 23 of the mounting in tensioning device 21, as seen in FIGS. 7, 8 and 9. The labial bow is tensioned by a double open-ended spring 28 bottomed at one end against the distal tubular guide 23 and at the other end against a crimpable stop 30 that is crimped onto the very ends of the labial bow. Accordingly, the labial bow is continually tensioned by a spring system to apply pressure against the labial forces of the anterior teeth.

The spring 28 preferably includes a closed end 32 bottoming against the distal tubular guide 23 and enclosed end 33 bottoming against the mesial end of the crimpable stop 30 and an open section 34. It will be appreciated that the spring 28 will be sized and tensioned such as to provide the desired tension to the distal ends of the labial bow 18 when the appliance is mounted onto the teeth of a patient.

The mounting and tensioning devices at the distal ends of the labial bow are connected to the lingual rigid base 37. This base is in the form a palate to engage the upper palate of a patient's mouth and would be custom made to fit against the lingual sides of the anterior and posterior teeth of a patient. If the retainer appliance is made for the lower jaw of a person, it would be appreciated that it would merely have a U-shaped lingual rigid base that would bear up against the lingual sides of the teeth of the patient. The rigid base 25 may be made out of any suitable orthodontic acrylic material and the material may be colored or opaque, such as a clear or transparent or colored polymer, which is castable, and, therefore, shaped to fit in the mouth of a person.

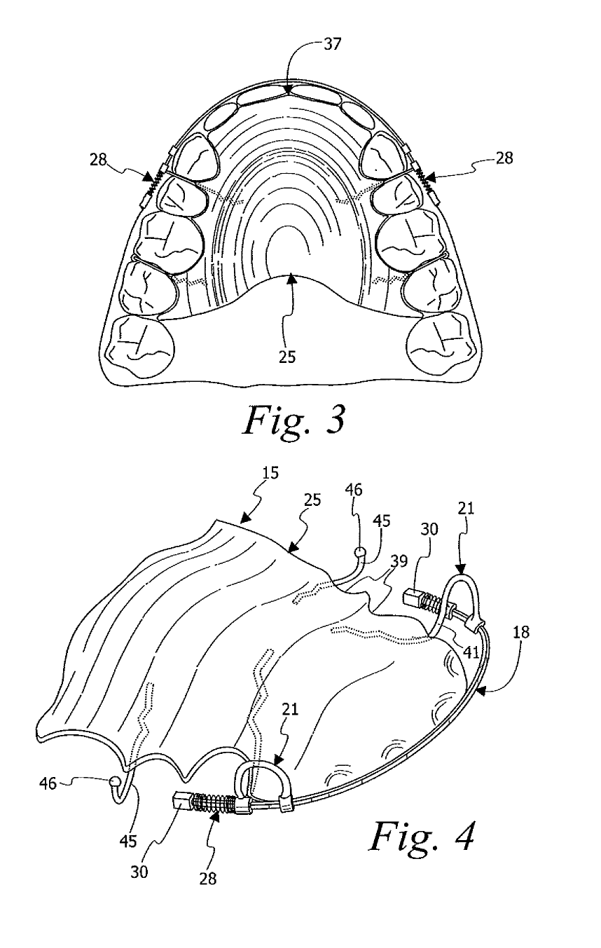

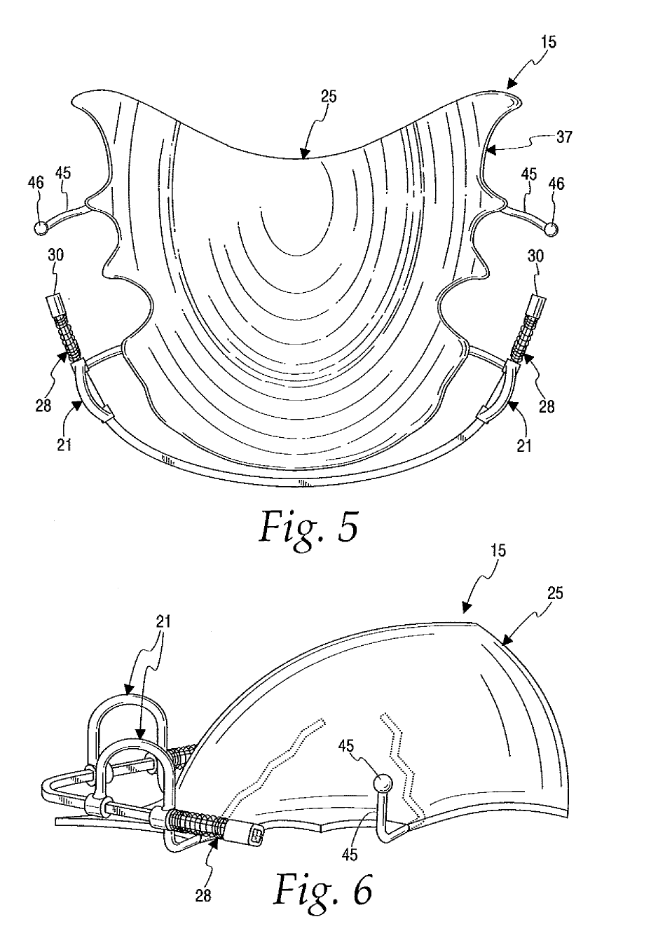

The rigid base 25 includes a lingual edge 37 that is shaped to bear against the lingual sides of the incisor teeth. It also includes a plurality of depressions or sockets 39 that fit against the cuspids and molars, as seen particularly in FIGS. 3 and 5. Thus, the lingual edge of the palatal rigid base is custom formed to fit against the patient's lingual surfaces of the teeth and provide a base against which particularly the incisors can move to their ideal position.

When mounting the retainer on the teeth of a patient, the patient would cause the rigid base to be positioned against the lingual of the teeth and the labial bow to be positioned against the labial surfaces of the incisor teeth, as shown in FIG. 3.

The mounting and tensioning devices 21 are also anchored to the rigid base 25 by connecting wires 41. Here again, these would be placed within the rigid base at the time of making the rigid base and constructing the retainer.

Further anchoring pins 45 with ball-shaped ends 46 are provided at the opposite sides of the rigid base and which when mounting the appliance on the teeth come over the crowns and lock into the labial embrasure areas of the first and second molars, as shown in FIG. 3. Like connecting wires 41, the pins 45 have ends molded into the rigid base 25.

It should be further appreciated that part of the appliance of the invention which constitutes a labial bow, the mountings for the distal ends of the labial bow, and the spring tensioning means at each end could be placed on any sort of a retainer that would serve to correct minor irregularities in the position of incisors as well as maintaining them in the ideal position.

While the invention has been described with respect to certain preferred embodiments, as will be appreciated by those of skill in the art, it is to be understood that the invention is capable of numerous changes, modifications and rearrangements which are intended to be covered by the following claims.

1. A removable orthodontic appliance for correcting minor anterior teeth irregularities of a patient and/or retaining said teeth in predetermined positions,
said appliance comprising means adapted for engaging labial sides of the anterior teeth and having distal ends,
said means including a flexible labial wire bow extending along and contacting the labial sides of said anterior teeth; and
resiliently activated means at the distal ends of said engaging means for applying tensional forces to said labial bow and said teeth.

2. A removable orthodontic appliance for correcting minor anterior teeth irregularities of a patient and/or retaining the anterior teeth in predetermined positions, said appliance being constructed over a plaster model or a setup of the patient's teeth, said appliance comprising:
a rigid base for lingually engaging the teeth and having means for anchoring said base to posterior teeth;
a flexible labial wire bow for engaging labial surfaces of the anterior teeth; and
means for anchoring distal ends of the bow to said base and applying a tensioning force to said bow.

3. The appliance of claim 2, wherein said labial bow is constructed of multi-stranded wire encased in tooth colored plastic to provide an aesthetically pleasing bow.

4. The appliance of claim 3, wherein said wire is braided.

5. The appliance of claim 3, wherein said means for anchoring includes stops at the distal ends of the wire and spaced wire guides through which said wire extends, said means for anchoring being connected to said base and having spring means on the distal ends of the wire between the stops and the guides for applying a constant tension to said wire.

6. The appliance of claim 5, wherein said spring means include double open-ended coil springs encircling said wire.

7. The appliance of claim 6, wherein said spring is nickel-titanium.

8. The appliance of claim 2, wherein said rigid base is a palatal plate for engaging lingual sides of the teeth.

9. The appliance of claim 1, wherein said labial bow is a substantially square in cross-section wire having a plurality of sides, one side of which is adapted to engage the labial sides of the teeth.

10. The appliance of claim 9, wherein said wire of the labial bow is nickel-titanium.

11. A labial bow assembly for a removable retainer appliance to provide forces on anterior teeth to correct for minor irregularities and/or to retain said teeth in ideal positions,
said assembly including a labial bow comprising multi-stranded nickel-titanium wire encased in plastic and having a substantially square cross-section and configured for positioning over labial surfaces of said anterior teeth;
said labial bow having distal ends spring-mounted to a lingually disposed stationary base connected to posterior teeth to continuously apply forces to the wire for engaging against the labial surfaces of the teeth.

12. The labial bow assembly of claim 11, wherein the multi-stranded wire is braided.

13. The labial bow assembly of claim 11, wherein each of the spring-mounted ends of said bow include a stationary guide connected to said base;
said guide having a pair of spaced apart mesial and distal interconnected tubular guide members through which the bow is threaded;
means connecting said tubular guide members to said stationary base on lingual surfaces of the teeth;
a spring on said bow bottomed on the distal-most tubular guide member;
and
a stop at the very ends of the bow against which the other end of the spring is bottomed.

14. The assembly of claim 13, wherein the stop is crimpable and having a coating that is esthetically pleasing.

15. A labial bow for a removable orthodontic retainer to apply forces to anterior teeth for retaining and/or urging the teeth into their most ideal positions;
said bow extending over the anterior teeth and distally to posterior teeth;
said bow comprising a flexible wire member overlying and engaging the anterior teeth and being of a length such as to extend to the posterior teeth;
means at distal ends of said bow for continuously applying resilient forces to said distal ends of said wire member;
said means including lingually positioned rigid means and labially positioned spaced apart mesial and distal guides through which the distal ends of the wire slidably extend;
a connection from the guides to said lingual rigid means; and
a spring over the distal ends of the wire bearing at one end against the distal guides and at the other end against a stop on distal ends of said wire.

16. A labial bow for a removable orthodontic retainer for a patient for correcting anterior teeth irregularities and/or retaining said teeth in predetermined positions,
said labial bow including a flexible member having multi-stranded flexible wire encased in plastic with a substantially square cross-section and adapted to be positioned over labial surfaces of the teeth; and
connecting means at distal ends of the labial bow to connect to a lingually mounted rigid base and to continuously apply a biasing force to said labial bow.

17. The labial bow of claim 16, wherein said connecting means includes a guide means extending from said rigid base for the distal ends of the bow, a stop secured to the very ends of said labial bow, and spring means coacting with the guide means and said stop to apply a bias to said labial bow to maintain said bow in contact with said anterior teeth.

18. The labial bow of claim 17, wherein said wire and said spring means are resilient nickel-titanium.

19. The labial bow of claim 16, wherein the wire is encased in an esthetically pleasing plastic having a flat surface engaging the teeth.

20. A labial wire bow for a removable orthodontic retainer for correcting minor irregularities and/or retaining anterior teeth in ideal positions;
said labial wire bow having a main section for engaging anterior teeth and distal ends and a connecting means for connecting to a lingually disposed rigid support means;
said labial wire bow comprising means supporting the distal ends of the bow and biasing the bow to apply forces to the anterior teeth, and a flexible wire member positioned over labial sides of the anterior teeth of a patient; and
said connecting means including a guide member at the distal ends and coacting springs for applying a bias to the labial bow.
